(19) United States
(12) Patent Application Publication
(10) Pub. No.: US 2017/0047007 A1
(43) Pub. Date: Feb. 16, 2017

(54) PIXEL CIRCUIT, DISPLAY DEVICE AND DRIVE METHOD THEREOF

(71) Applicant: BOE TRCHNOLOGY GROUP CO., LTD., Beijing (CN)

(72) Inventors: Jingwen YIN, Beijing (CN); Lirong WANG, Beijing (CN)

(73) Assignee: Boe Technology Group Co., Ltd.

(21) Appl. No.: 15/021,332

(22) PCT Filed: Aug. 10, 2015
(86) PCT No.: PCT/CN2015/086471

§ 371 Date: Mar. 11, 2016

(30) Foreign Application Priority Data
Apr. 3, 2015 (CN) 201510158292.6

(51) Int. Cl. G09G 3/3258; G09G 3/3266; G09G 3/3291; G09G 3/325

(52) U.S. Cl. CPC G09G 3/3258; G09G 3/325; G09G 3/3266; G09G 3/3291; G09G 2300/0809; G09G 2320/0646; G09G 2320/0233; G09G 2300/0842

(57) ABSTRACT

The present disclosure provides a pixel circuit comprising a light-emitting element, a drive transistor comprising a first electrode for receiving a first level signal and a second electrode for providing a drive current to the light-emitting element, and a storage module for storing data inputted in a data write phase and providing the data to a gate of the drive transistor in a light-emitting phase, wherein a first terminal of the storage module is connected with the gate of the drive transistor, and a second terminal of the storage module is connected with a second electrode of the drive transistor. The storage module is further configured to store a threshold voltage of the drive transistor. The present disclosure further provides a display device and a drive method. When the display device performs display, brightness of the light-emitting element does not vary with a threshold drift of the drive transistor.

### RELATED APPLICATIONS

The present application is the U.S. national phase entry of PCT/CN2015/086471, with an international filing date of Aug. 10, 2015, which claims the benefit of Chinese Patent Application No. 201510158292.6, filed on Apr. 3, 2015, the entire disclosures of which are incorporated herein by reference.

### TECHNICAL FIELD

The present disclosure relates to the field of organic light-emitting diode display, and specifically to a pixel circuit, a display device comprising the pixel circuit and a method for driving the display device.

### BACKGROUND

An organic light-emitting display is presently popular in the field of flat panel display research. As compared with a liquid crystal display, the organic light-emitting diode has advantages such as low energy consumption, low production cost, self light emission, wide view angle and quick response speed. Currently, in the field of display of mobile phones, PDA's, digital cameras, and the like, the organic light-emitting display panel begins to be used in place of the conventional liquid crystal display panel. Pixel drive circuit design is core technical content of an active matrix organic light-emitting diode display panel (AMOLED) and is of great research significance.

Unlike the liquid crystal panel in which a stable voltage is used for control of brightness, the organic light-emitting diode subjects to electrical current drive and needs a stable current to control light emission.

FIG. 1 shows a commonly-used 2T1C pixel circuit which includes a storage capacitor C, a drive transistor DTFT and a switch transistor T0. When a scanning line scans a row of pixels, the switch transistor T0 turns on, and a data write signal (the data write signal is voltage here) is written to the storage capacitor C. Upon completion of the scanning of the row, the switch transistor T0 turns off, and the voltage stored in the storage capacitor C drives the drive transistor DTFT to enable it to generate a current to drive the light-emitting element OLED to ensure constant light emission of the light-emitting element in a frame. A saturation current of the drive transistor DTFT is I_{OLED}=K(V_{Gs}−Vₜₕ)², where I_{OLED} is the saturation current of the drive transistor DTFT, V_{Gs} is a gate-source voltage of the drive transistor DTFT, Vₜₕ is a threshold voltage of the drive transistor DTFT, and K is a parameter related to a light-emitting element.

Due to factors such as process and device aging, the threshold voltage of the drive transistor of pixel points is uneven, which causes changes in the current flowing through the organic light-emitting diode in each pixel point so that the display brightness is uneven, thereby affecting the display effect of the whole image.

Hence, improving brightness uniformity of the display panel is a technical problem that requires an urgent solution.

### SUMMARY

An object of the present disclosure is to provide a pixel circuit, a display device comprising the pixel circuit and a drive method of the display device to provide even display brightness.

To achieve this, according to an aspect of the present disclosure, there is provided a pixel circuit comprising a light-emitting element, a drive transistor comprising a first electrode for receiving a first level signal and a second electrode for providing a drive current to the light-emitting element, and a storage module for storing data inputted in a data write phase and providing the data to a gate of the drive transistor in a light-emitting phase, wherein a first terminal of the storage module is connected with the gate of the drive transistor, and a second terminal of the storage module is connected with a second electrode of the drive transistor. The storage module is further configured to store a threshold voltage of the drive transistor.

In an embodiment, the storage module is configured to connect the gate of the drive transistor with the second electrode when the first level signal is at a low level. The first level signal is at a low level prior to the data write phase and at a high level in the data write phase and the light-emitting phase.

In an embodiment, a data write module comprises a data write transistor. A gate of the data write transistor is connected with a first gate line, a first electrode of the data write thin film transistor may be connected with a data line in the data write phase, and a second electrode of the data write thin film transistor is connected with a third terminal of the storage module.

In an embodiment, the first electrode of the data write thin film transistor may be connected with a reference voltage line in a reset phase prior to start of the data write phase.

In an embodiment, the storage module comprises a first storage capacitor disposed between the third terminal and first terminal of the storage module, a second storage capacitor disposed between the third terminal of the storage module and a ground level, and a control transistor. A first terminal of the first storage capacitor is connected to an output terminal of the data write module, and a second terminal of the first storage capacitor is connected with the gate of the drive transistor. A first terminal of the second storage capacitor is connected with the first terminal of the first storage capacitor, and a second terminal of the second storage capacitor is grounded. The gate of the control transistor is connected with a second gate line, the first electrode of the control transistor is connected with the first terminal of the first storage capacitor, and the second electrode of the control transistor is connected with the second terminal of the drive transistor.

According to another aspect of the present disclosure, there is provided a display device which comprises a power supply and N×M pixel cells divided and arranged in N rows and M columns, wherein N and M are integers greater than 1. Each of said pixel cells is provided therein with the pixel circuit as described above. The power supply is used to provide a first level signal to the pixel circuit and the power supply is configured to provide a low-level signal prior to the data write phase and provide a high-level signal in the data write phase and light-emitting phase.

In an embodiment, the display device comprises N sets of gate lines and M data lines, the N sets of gate lines correspond one-to-one with N rows of said pixel cells, and the M data lines correspond one-to-one with M columns of said pixel cells. Each set of gate lines comprises a first gate line for providing a control signal to a gate of a data write transistor of a data write module to provide data from the data line to the storage module. The gate of the data write transistor is connected with the first gate line, a first electrode of the data write transistor may be connected with the data line in the data write phase, and a second electrode of the data write transistor is connected with the storage module.

In an embodiment, the display device further comprises a reference voltage line for providing a reference voltage to the first electrode of the data write transistor in a reset phase prior to the data write phase.

In an embodiment, the reference voltage line is formed integrally with the data line.

In an embodiment, each set of said gate lines further comprises a second gate line for controlling a control transistor connected between the first terminal and second terminal of the storage module. The storage module comprises a first storage capacitor, a second storage capacitor and a control thin film transistor, a first terminal of the first storage capacitor is connected with an output terminal of the data write module, a second terminal of the first storage capacitor is connected with a gate of the drive thin film transistor, a first terminal of the second storage capacitor is connected with the first terminal of the first storage capacitor, a second terminal of the second storage capacitor is grounded, a gate of the control thin film transistor is connected with the second gate line, a first electrode of the control thin film transistor is connected with the first terminal of the first storage capacitor, and a second electrode of the control thin film transistor is connected with the second electrode of the drive thin film transistor.

According to a further aspect of the present disclosure, there is provided a drive method for driving the above display device. The drive method comprises a plurality of display cycles, each display cycle including a reset and threshold voltage collecting phase, a data write phase and a light-emitting phase. The drive method comprises: providing, in the reset and threshold voltage collecting phase, a low level from the power supply to the drive transistor so that the storage module stores the threshold voltage of the drive transistor; and providing a high level from the power supply to the drive transistor in the data write phase and the light-emitting phase.

In an embodiment, the display device comprises N sets of gate lines and M data lines, the N sets of gate lines correspond one-to-one with N rows of said pixel cells, and the M data lines correspond one-to-one with M columns of said pixel cells, wherein N and M are integers greater than 1. Each set of gate lines comprises a first gate line for providing a control signal to a data write transistor of a data write module to provide data from the data line to the storage module. The drive method comprises: in the data write phase, providing a level enabling the data write transistor to turn on to a gate of the data write transistor via the first gate line, and providing a data voltage to a first electrode of the transistor via the data line; and in the light-emitting phase, providing a level enabling the data write transistor to turn off to the gate of the data write transistor via the first gate line.

In an embodiment, the drive method comprises: in the reset and threshold voltage collecting phase, providing a level enabling the data write transistor to turn on to the gate of the data write transistor via the first gate line, and providing a reference voltage to the first electrode of the data write transistor via the data line.

In an embodiment, each set of said gate lines further comprises a second gate line for controlling a control transistor disposed between the first terminal and second terminal of the storage module. According to an embodiment, the storage module comprises a first storage capacitor, a second storage capacitor and a control thin film transistor, a first terminal of the first storage capacitor is connected with an output terminal of the data write module, a second terminal of the first storage capacitor is connected with a gate of the drive transistor. A first terminal of the second storage capacitor is connected with the first terminal of the first storage capacitor, and a second terminal of the second storage capacitor is grounded. A gate of the control transistor is connected with the second gate line, a first electrode of the control transistor is connected with the first terminal of the first storage capacitor, and a second electrode of the control transistor is connected with the second electrode of the drive thin film transistor, wherein:

a level enabling the control transistor to turn on is provided to the second gate line in the reset and threshold voltage collecting phase;

in the data write phase, a level enabling the control transistor to turn off is provided to the second gate line; and

in the light-emitting phase, a level enabling the control transistor to turn off is provided to the second gate line.

In the pixel circuit provided in the present disclosure, the impact is eliminated that is exerted by the drift of the threshold voltage of the drive transistor to the current flowing through the light-emitting element, the brightness uniformity of the display panel including the pixel circuit may be improved, and display defects such as ghosting will not occur when the display panel performs display, thereby optimizing the display effect of the display panel.

### BRIEF DESCRIPTION OF THE DRAWINGS

The figures described here are used to provide further understanding to the present disclosure and form a portion of the description. The figures, together with the following detailed description, are used to illustrate the present disclosure, and are not to be construed as limiting the present disclosure. In the figures:

FIG. 1 is a circuit diagram of an existing 2T1C pixel circuit;

FIG. 2 is a module schematic view of a pixel circuit according to an embodiment of the present disclosure;

FIG. 3 is a schematic diagram of a pixel circuit according to an embodiment of the present disclosure;

FIG. 4 is a signal time sequence diagram of a drive pixel circuit according to an embodiment of the present disclosure;

FIG. 5 is an equivalent circuit diagram wherein the pixel circuit shown in FIG. 3 is in a reset and threshold collecting phase;

FIG. 6 is an equivalent circuit diagram wherein the pixel circuit shown in FIG. 3 is in a data write phase; and

FIG. 7 is an equivalent circuit diagram wherein the pixel circuit shown in FIG. 3 is in a light-emitting phase.

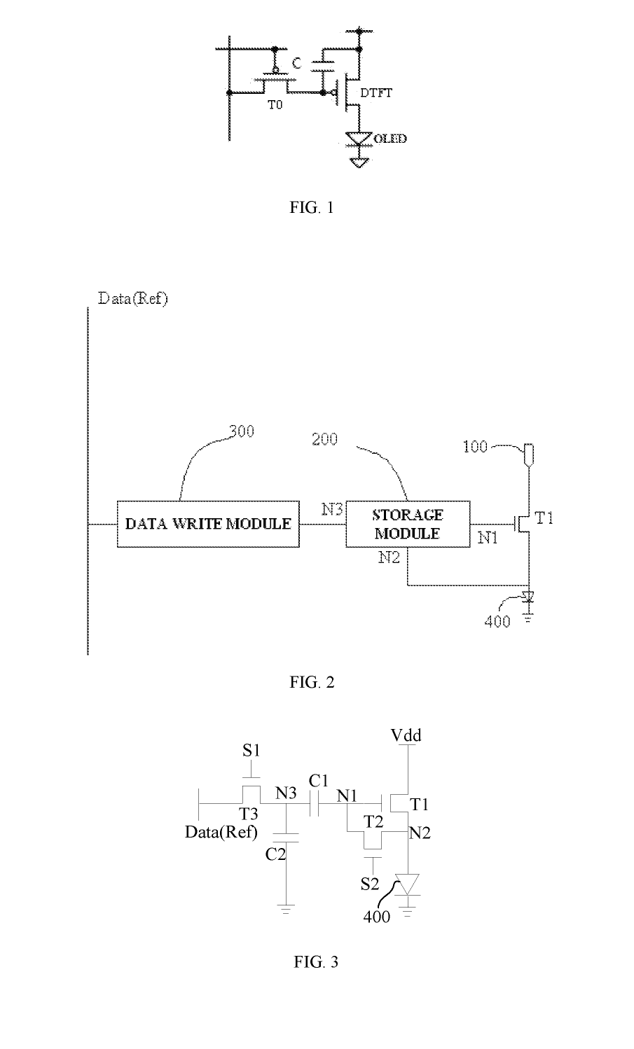

### DETAILED DESCRIPTION

Embodiments of the present disclosure will be described in detail with reference to the accompanying drawings. The following list describes the reference numbers used throughout the drawings:

| | |
|---|---|
| T1: drive thin film transistor | T2: control thin film transistor |
| T3: data write thin film transistor | C1: first storage capacitor |
| C2: second storage capacitor | 100: power supply terminal |
| 200: storage module | 300: data write module |
| 400: light-emitting element | S1: first gate line |
| S2: second gate line | |

It should be appreciated that embodiments described here are only used to describe and illustrate the present disclosure, not to limit the present disclosure.

FIG. 2 is a module schematic view of a pixel circuit according to an embodiment of the present disclosure. As shown in FIG. 2, as one aspect of the present disclosure, there is provided a pixel circuit which comprises a power supply terminal 100, a drive thin film transistor T1, a light-emitting element 400, a data write module 300 and a storage module 200. A gate of the drive thin film transistor T1 is connected with a first terminal N1 of the storage module 200, a first electrode of the drive thin film transistor T1 is connected with the power supply terminal 100, a second electrode of the drive thin film transistor T1 is connected with an anode of the light-emitting element 400, and a second electrode of the drive thin film transistor T1 is connected with a second terminal N2 of the storage module 200. The data write module 300 is used to write data voltage (i.e., Vdata) into the storage module 200 in a data write phase. The storage module 200 is used to store the data voltage Vdata in the data write phase, and to provide the data voltage Vdata to the gate of the drive thin film transistor T1 at least in a light-emitting phase. The power supply terminal 100 can receive a low-level voltage (i.e., Vss) prior to the data write phase, and the storage module 200 can connect the gate of the drive thin film transistor T1 with the second electrode of the drive thin film transistor T1 when the power supply terminal 100 is at the low-level voltage Vss, so that the storage capacitor discharges and stores the threshold voltage of the drive thin film transistor. The power supply terminal is at a high level in the data write phase and after the data write phase, so as to enable the light-emitting elements 400 to emit light.

Those skilled in the art should appreciate that the light-emitting element 400 is usually an organic light-emitting diode. Furthermore, in a working cycle of a pixel circuit in the display device, the last phase is a light-emitting phase of the pixel circuit. The pixel circuit works continuously, such that when the working cycle begins, a state maintained by the storage module 200 is a state in which the pixel circuit was upon completion of a previous working cycle. At the last phase of the previous working cycle, to enable the pixel circuit to emit light in the light-emitting phase, the first terminal of the storage module 200 should be at a high level enabling the drive thin film transistor T1 to turn on. When a next working cycle of the pixel circuit starts (namely, prior to the data write phase as stated above), the power supply terminal 100 provides the low-level voltage Vss prior to the data write phase. Hence, the storage module 200 discharges to the power supply terminal 100 via the drive thin film transistor T1. Upon completion of the discharge, the voltage stored in the storage module 200 is a voltage associated with Vth+Vss; that is, after completion of the discharge, the voltage on the first terminal N1 of the storage module 200 is a voltage associated with Vth+Vss, wherein Vth is a threshold voltage of the drive thin film transistor T1 (i.e., after completion of the discharge, the storage module 200 stores the threshold voltage of the drive thin film transistor T1).

In the data write phase, the data voltage Vdata enabling the light-emitting element 400 in the pixel circuit to emit light is written into the storage module 200 by the data write module 300. Furthermore, in the data write phase, the voltage on the power supply terminal 100 is a high-level voltage Vdd. Therefore, the whole pixel circuit will not discharge to the power supply terminal 100. After the data write phase, the voltage in the storage module 200 is a combination of the data voltage Vdata and the voltage Vth+Vss on the first terminal N1 of the storage module 200.

In the light-emitting phase, drive current I₄₀₀ generated by the drive thin film transistor T1 satisfies the following equation:

I₄₀₀=0.5K(Vgs−Vth)²

where K is a parameter related to the light-emitting element itself;

Vgs is a gate-source voltage of the drive thin film transistor; and

Vth is the threshold voltage of the drive thin film transistor.

In the first phase, the storage module 200 stores the threshold voltage Vth of the drive thin film transistor T1, and the threshold voltage of the drive thin film transistor T1 is subtracted in the above equation. Hence, the drive current of the light-emitting element 400 becomes irrelevant to the threshold voltage of the drive thin film transistor T1 so as to eliminate impact exerted by drift of the threshold voltage of the drive thin film transistor T1 to the pixel circuit and thereby improve the stability of light emission of the display device.

In the pixel circuit provided by the present disclosure, the storage module 200 may be enabled to store the threshold voltage of the drive thin film transistor T1 only by changing the input voltage of the power supply terminal 100. Hence, a dedicated threshold voltage compensation module needs not be disposed in the pixel circuit, thereby simplifying the structure of the pixel circuit, improving the aperture ratio of a single pixel, and saving the total cost for manufacturing the display device.

In the present disclosure, the structure of the data write module 300 is not defined specifically so long as the pixel voltage Vdata enabling the light-emitting element 400 to emit light can be written via the data write module 300. As a specific embodiment of the present disclosure, as shown in FIG. 3, the data write module 300 may comprise a data write thin film transistor T3. A gate of the data write thin film transistor T3 is connected with a first gate line S1, a first electrode of the data write thin film transistor T3 can be connected with a data line Data in the data write phase, and a second electrode of the data write thin film transistor T3 is connected with the storage module 200.

The first gate line S1 provides an enable signal for the gate of the data write thin film transistor T3 at least in the data write phase, so that the data write thin film transistor T3 turns on. Hence, at least in the data write phase, the data voltage Vdata is written into the storage module 200 via the data write thin film transistor T3. The data write module in this specific embodiment only comprises one thin film transistor (namely, the data write thin film transistor T3) and is simple in structure.

To further simplify the structure of the pixel circuit, the first electrode of the data write thin film transistor T3 may be connected with a reference voltage line in a reset phase prior to start of the data write phase. Hence, a reference voltage Vref for reset purposes may be provided for the storage module 200 via the data write thin film transistor T3.

In the present disclosure, the structure of the storage module 200 is not defined especially so long as the threshold voltage Vth of the drive thin film transistor T1 is stored prior to the start of the data write phase, and the data voltage Vdata is stored in the data write phase, as stated above. As a specific embodiment, as shown in FIG. 3, the storage module 200 may comprise a first storage capacitor C1, a second storage capacitor C2 and a control thin film transistor T2. A first terminal of the first storage capacitor C1 is connected with an output terminal N3 of the data write module 200, a second terminal of the first storage capacitor C1 is connected with the gate of the drive thin film transistor T1. A first terminal of the second storage capacitor C2 is connected with the first terminal of the first storage capacitor C1, and a second terminal of the second storage capacitor C2 is grounded. A gate of the control thin film transistor T2 is configured to be connected with a second gate line S2, a first electrode of the control thin film transistor T2 is connected with the first terminal of the first storage capacitor C1, and a second electrode of the control thin film transistor T2 is connected with the second electrode of the drive thin film transistor T1.

In the storage module 200 having the above structure, the first storage capacitor C1 is used to store the threshold voltage Vth of the drive thin film transistor T1, and the second storage capacitor C2 is used to store the data voltage Vdata.

FIG. 3 shows a specific embodiment of the pixel circuit provided by the present disclosure. As shown in the figure, the pixel circuit has a simple 3T2C structure so that the display device including the pixel circuit has a high aperture ratio and low cost.

According to another aspect of the present disclosure, there is provided a display device which comprises a power supply and N×M pixel cells divided and arranged in N rows×M columns, wherein N and M are integers greater than 1. Each of the pixel cells is provided therein with the pixel circuit according to embodiments of the present disclosure. The power supply is used to provide a first level signal to the pixel circuit, and the power supply is configured to provide the low-level signal Vss prior to the data write phase and provide a high-level signal Vdd in the data write phase and light-emitting phase.

As stated above, since the power supply provides the low-level voltage Vss prior to the data write phase, before the data write phase, the storage module 200 of the pixel circuit may store the threshold voltage Vth of the drive thin film transistor T1 so that the drive current generated in the light-emitting phase of the light-emitting element is not affected by the threshold voltage Vth of the drive thin film transistor T1.

When the display device performs display, a plurality of rows of pixel cells usually need to be scanned row by row, and then a gray-scale signal (namely, the data voltage Vdata) is provided for each column of pixel cells through the data line. Correspondingly, the display device comprises N sets of gate lines and M data lines, the N sets of gate lines correspond one-to-one with N rows of the pixel cells, and the M data lines correspond one-to-one with M columns of the pixel cells. In a specific embodiment in which the data write module 300 comprises the data write thin film transistor T3, each set of gate lines may comprise a first gate line S1. Therefore, the gate of the data write thin film transistor T3 is connected with the first gate line S1, the first electrode of the data write thin film transistor T3 can be connected with the data line Data in the data write phase, and the second electrode of the data write thin film transistor T3 is connected with a third terminal N3 of the storage module 200.

In the data write phase, an activation voltage is provided to the gate of the data write thin film transistor T3 via the first gate line S1 so that the data write thin film transistor T3 turns on, and the data voltage Vdata provided through the data line Data may be written in the storage module 200.

To simplify the structure of the pixel circuit, the data write module 300 may be used to write a reset voltage to the storage module 200. In this embodiment, the display device further comprise a reference voltage line Ref, and the first electrode of the data write thin film transistor T3 can be connected with the reference voltage line Ref in the reset phase prior to the start of the data write phase. It is appreciated that in the reset phase, the first gate line S1 still provides the activation voltage to the gate of the data write thin film transistor T3.

To simplify the structure of the display device, in an embodiment as shown in FIG. 2, the reference voltage line Ref is formed integrally with the data line Data. In the data write phase and the light-emitting phase, the data voltage Vdata is provided to the data line, and in the reset phase prior to the data write phase, the reference voltage Vref is provided to the data line Data, in which case the data line serves as the reference voltage line Ref.

In an embodiment in which the storage module 200 comprises the first storage capacitor C1, the second storage capacitor C2 and the control thin film transistor T2, each set of gate lines comprises a second gate line S2, which is connected with the gate of the control thin film transistor T2.

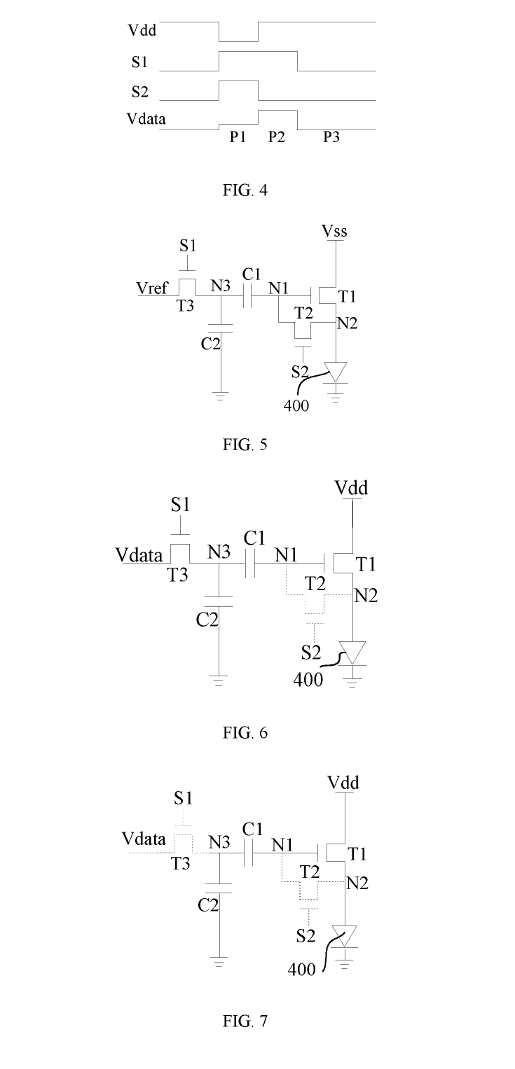

The working principle of the pixel circuit having 3T2C structure provided in FIG. 3 will be described in connection with FIGS. 4 to 7.

As shown in FIG. 4, each working cycle of the pixel circuit comprises three phases, namely, a reset and threshold voltage collecting phase P1, a data write phase P2 and a light-emitting phase P3.

In the reset and threshold voltage collecting phase P1, the power supply provides the low-level voltage Vss to the power supply terminal 100, the first gate line S1 is supplied with a high level, the second gate line S2 is supplied with a high level, and the data line serves as the reference voltage line and is supplied with the reference voltage Vref.

FIGS. 5 to 7 are equivalent circuit diagrams of the pixel circuit in different working phases, wherein lighter-colored portions of the circuit indicate that those portions are switched-off.

As shown in FIG. 5, the drive thin film transistor T1, the data write thin film transistor T3 and the control thin film transistor T2 are all turned on. On this basis, the voltage on the third terminal N3 of the storage module is Vref, and the second storage capacitor C2 will be reset. The voltage on the first terminal N1 of the storage module is discharged to Vth+Vss because the drive thin film transistor T1 forms a diode connection, and the threshold voltage Vth of the drive thin film transistor T1 is stored in the first storage capacitor C1, in which case the light-emitting element 400 is in a turn-off state and does not emit light.

In the data write phase P2, the power supply provides the high-level voltage Vdd to the power supply terminal 100, the first gate line S1 is supplied with a high level, the second gate line S2 is supplied with a low level, the data line serves as the data line and is supplied with the data voltage Vdata.

As shown in FIG. 6, the control thin film transistor T2 is turned off, the voltage on the third terminal N3 of the storage module becomes Vdata because the data write thin film transistor T3 is turned on, and the data voltage Vdata is stored in the second storage capacitor C2, in which case the voltage on the first terminal N1 of the storage module also experiences a corresponding voltage boost and becomes Vdata+Vth+Vss−Vref.

In the light-emitting phase P3, both the first gate line S1 and second gate line S2 are supplied with a low level, and both the control thin film transistor T2 and the data write thin film transistor T3 are in a closed state. Hence, as shown in FIG. 7, at this point, the first electrode of the drive thin film transistor T1 is connected to the high-level voltage Vdd, and the voltage on the second electrode of the drive thin film transistor T1 is V₄₀₀+V_{SS}, wherein V₄₀₀ is a voltage across the light-emitting element 400. Thus, the gate-source voltage Vgs of the drive thin film transistor T1 is Vdata+Vth-Vref-V₄₀₀. As such, in the light-emitting phase P3, the drive current I₄₀₀ generated by the drive thin film transistor T1 may be presented as the following formula:

$$\begin{matrix}{I}_{400} = 0.5 K \times {( Vgs - Vth )}^{2} \\ = 0.5 K \times {( Vdata + Vth - Vref - {V}_{400} - Vth )}^{2} \\ = 0.5 K \times {( Vdata - Vref - {V}_{oled} )}^{2}\end{matrix}$$

As known from the above, the drive current of the light-emitting element 400 is irrelevant to the threshold voltage of the drive thin film transistor T1. Hence, while the display device performs display, the brightness of the light-emitting element 400 will not become uneven due to the drift of the threshold voltage of the drive thin film transistor T1.

Moreover, in the whole display procedure, the drive thin film transistor T1 works alternately in positive and negative biased states. Specifically, in the reset and threshold voltage collecting phase P1, the first electrode of the drive thin film transistor T1 is a drain, and the second electrode is a source. In the light-emitting phase P3, the first electrode of the drive thin film transistor T1 is a source, and the second electrode is a drain. That is to say, in the reset and threshold voltage collecting phase P1 and the light-emitting phase P3, the source and drain of the drive thin film transistor T1 are exactly opposite, thereby easing the drift speed of the threshold voltage of the drive thin film transistor T1. Furthermore, since the drive current I₄₀₀ is irrelevant to the power supply voltage, the display brightness of the light-emitting element 400 is no longer affected by a power supply line resistance voltage drop (I-R Drop).

The display device according to the present disclosure may be a television set, a computer display screen, a mobile phone, a navigator or the like.

According to a further aspect of the present disclosure, there is provided a drive method of a display device. The display device is the aforesaid display device provided by the present disclosure. The drive method comprises a plurality of display cycles, each display cycle including a reset and threshold voltage collecting phase, a data write phase and a light-emitting phase. The drive method comprises: in the reset and threshold voltage collecting phase, providing a low level to the power supply terminal by using the power supply so that the storage module discharges and stores the threshold voltage of the drive thin film transistor; and providing a high level to the power supply terminal in the data write phase and the light-emitting phase.

According to a specific embodiment of the present disclosure, the display device comprises N sets of gate lines and M data lines, the N sets of gate lines correspond one-to-one with N rows of said pixel cells, and the M data lines correspond one-to-one with M columns of said pixel cells, wherein N and M are integers greater than 1. Each set of gate lines comprises a first gate line, the data write module comprises a data write thin film transistor, a gate of the data write thin film transistor is connected with the first gate line, a first electrode of the data write thin film transistor can be connected with the data line in the data write phase, and a second electrode of the data write thin film transistor is connected with the storage module.

In an embodiment in which the display device has the above structure, the drive method comprises: in the data write phase, providing a level enabling the data write thin film transistor to turn on to the gate of the data write thin film transistor via the first gate line, and providing a data voltage to the first electrode of the thin film transistor via the data line; and in the light-emitting phase, providing a level enabling the data write thin film transistor to turn off to the gate of the data write thin film transistor via the first gate line, and providing a data voltage to the second electrode of the thin film transistor via the data line.

In an embodiment, the drive method comprises the following steps performed prior to the data write phase: providing a level enabling the data write thin film transistor to turn on to the gate of the data write thin film transistor via the first gate line, and providing a reference voltage to the first electrode of the thin film transistor via the data line.

The display device may have the following structure: each set of said gate lines further comprises a second gate line, the storage module comprises a first storage capacitor, a second storage capacitor and a control thin film transistor, a first terminal of the first storage capacitor is connected with an output terminal of the data write module, a second terminal of the first storage capacitor is connected with a gate of the drive thin film transistor, a first terminal of the second storage capacitor is connected with the first terminal of the first storage capacitor, a second terminal of the second storage capacitor is grounded, a gate of the control thin film transistor is connected with the second gate line, a first electrode of the control thin film transistor is connected with the first terminal of the first storage capacitor, and a second electrode of the control thin film transistor is connected with the second electrode of the drive thin film transistor.

In an embodiment in which the display device has the above structure, the step performed prior to the data write phase is the reset and threshold voltage collecting phase, during which a level enabling the control thin film transistor to turn on is provided to the second gate line. In the data write phase, a level enabling the control thin film transistor to turn off is provided to the second gate line. In the light-emitting phase, a level enabling the control thin film transistor to turn off is provided to the second gate line.

The drive method provided by the present disclosure has already been described in detail in connection with the figures, and will not be detailed here for simplicity.

It may be appreciated that the above embodiments are only exemplary embodiments for illustrating the principle of the present disclosure, and that the present disclosure is not so limited. Various variations and improvements may be made by those of ordinary skill in the art without departing from the spirit and essence of the present disclosure, and these variations and improvements are considered as falling within the protection scope of the present disclosure.

1. A pixel circuit comprising:
a light-emitting element;
a drive transistor comprising a first electrode for receiving a first level signal and a second electrode for providing a drive current to the light-emitting element; and
a storage module for storing data inputted in a data write phase and providing the data to a gate of the drive transistor in a light-emitting phase,
wherein a first terminal of the storage module is connected with the gate of the drive transistor, and a second terminal of the storage module is connected with a second electrode of the drive transistor, and
wherein the storage module is further configured to store a threshold voltage of the drive transistor.

2. The pixel circuit according to claim 1, wherein the storage module is configured to connect the gate of the drive transistor with the second electrode when the first level signal is at a low level.

3. The pixel circuit according to claim 2, wherein the first level signal is at a low level prior to the data write phase and at a high level in the data write phase and the light-emitting phase.

4. The pixel circuit according to claim 1, further comprising a data write module configured to input a data signal to the storage module in the data write phase.

5. The pixel circuit according to claim 4, wherein the data write module comprises a data write transistor, wherein a gate of the data write transistor is connected with a first gate line, and wherein a first electrode of the data write transistor is configured to receive a signal from a data line in the data write phase, and a second electrode of the data write transistor that is connected with a third terminal of the storage module.

6. The pixel circuit according to claim 4, wherein the first electrode of the data write transistor is configured to be connected with a reference voltage line in a reset phase prior to start of the data write phase.

7. The pixel circuit according to claim 5, wherein the storage module comprises:
a first storage capacitor disposed between the third terminal and first terminal of the storage module,
a second storage capacitor disposed between the third terminal of the storage module and a ground level, and
a control transistor configured to control a circuit connection between the first terminal and third terminal of the storage module, a gate of the control transistor connected with a second gate line.

8. A display device comprising a power supply and N×M pixel cells divided and arranged in N rows×M columns, where N and M are integers greater than 1, each of said pixel cells being provided therein with a pixel circuit according to claim 1,
wherein the power supply is used to provide a first level signal to the pixel circuit and the power supply is configured to provide a low-level signal prior to a data write phase and provide a high-level signal in the data write phase and a light-emitting phase.

9. The display device according to claim 8, wherein the display device comprises N sets of gate lines and M data lines, the N sets of gate lines correspond one-to-one with N rows of said pixel cells, and the M data lines correspond one-to-one with M columns of said pixel cells, and
wherein each set of gate lines comprises a first gate line for providing a control signal to a gate of a data write transistor of the data write module to provide data from the data line to the storage module.

10. The display device according to claim 9, further comprising a reference voltage line for providing a reference voltage to a first electrode of the data write transistor in a reset phase prior to the data write phase.

11. The display device according to claim 10, wherein the reference voltage line is formed integrally with the data line.

12. The display device according to claim 9, wherein each set of said gate lines further comprises a second gate line configured to control a control transistor connected between the first terminal and second terminal of the storage module.

13. A drive method for driving the display device according to claim 8, the drive method comprising a plurality of display cycles, each of said display cycles including a reset and threshold voltage collecting phase, a data write phase and a light-emitting phase, the drive method comprising:
in the reset and threshold voltage collecting phase, providing a low level from the power supply to the drive transistor so that the storage module stores the threshold voltage of the drive transistor; and
providing a high level from the power supply to the drive transistor in the data write phase and the light-emitting phase.

14. The drive method according to claim 13, wherein the display device comprises N sets of gate lines and M data lines, wherein the N sets of gate lines correspond one-to-one with N rows of said pixel cells, and the M data lines correspond one-to-one with M columns of said pixel cells, where N and M are integers greater than 1, each set of gate line comprising a first gate line for providing a control signal to a data write transistor of a data write module to provide data from the data line to the storage module, the drive method comprising:
in the data write phase, providing a level enabling the data write transistor to turn on to a gate of the data write transistor via the first gate line, and providing a data voltage to a first electrode of the data write transistor via the data line; and
in the light-emitting phase, providing a level enabling the data write transistor to turn off to the gate of the data write transistor via the first gate line.

15. The drive method according to claim 14, further comprising in the reset and threshold voltage collecting phase:
providing a level enabling the data write transistor to turn on to the gate of the data write transistor via the first gate line, and providing a reference voltage to the first electrode of the data write transistor via the data line.

16. The drive method according to claim 14, wherein each set of said gate lines further comprises a second gate line configured to control a control transistor disposed between the first terminal and second terminal of the storage module, the drive method comprising:
in the reset and threshold voltage collecting phase, providing a level enabling the control transistor to turn on to the second gate line;
in the data write phase, providing a level enabling the control transistor to turn off to the second gate line; and
in the light-emitting phase, providing a level enabling the control transistor to turn off to the second gate line.

17. The pixel circuit according to claim 6, wherein the storage module comprises:
a first storage capacitor disposed between the third terminal and first terminal of the storage module,
a second storage capacitor disposed between the third terminal of the storage module and a ground level, and
a control transistor configured to control a circuit connection between the first terminal and third terminal of the storage module, wherein a gate of the control transistor is connected with a second gate line.

18. The display device according to claim 10, wherein each set of said gate lines further comprises a second gate line configured to control a control transistor connected between the first terminal and second terminal of the storage module.

19. The display device according to claim 11, wherein each set of said gate lines further comprises a second gate line configured to control a control transistor connected between the first terminal and second terminal of the storage module.
